(19) United States
(12) Patent Application Publication
(10) Pub. No.: US 2025/0284824 A1
(43) Pub. Date: Sep. 11, 2025

(54) METHOD FOR AUTOMATIC DETECTION AND REMEDIATION OF SECURITY POSTURE IN WEB-APPLICATIONS USING LARGE VISION MODELS

(71) Applicant: RedBlock Security, Inc, Dublin, CA (US)

(72) Inventors: Indus Khaitan, Dublin, CA (US); Aviral Srivastava, Bengaluru (IN)

(21) Appl. No.: 19/076,308

(22) Filed: Mar. 11, 2025

Related U.S. Application Data
(60) Provisional application No. 63/563,923, filed on Mar. 11, 2024.

(51) Int. Cl. G06F 21/57

(52) U.S. Cl. CPC G06F 21/577; G06F 2221/033

(57) ABSTRACT

A method for automatic detection and remediation of security posture in web-applications using large vision models is fulfilled in the ongoing description by (a) initiating a headless browser as an agent to access an administrative section of a web-application, (b) enabling a pre-trained large vision model to navigate through a web user-interface of the web-application using a state transition graph, (c) determining subsequent navigation actions of the navigated web-user interface using screenshots of the navigated web-user interface with the large vision model, (d) detecting and analyzing a final state of navigation sequence of the administrative section to extract security attributes, (e) monitoring and collecting data associated with security posture of the web-application based on the security attributes, and (f) initiating automated corrective actions through a security posture remediation module upon identifying a security issue in the web-application.

### BACKGROUND

### Technical Field

The embodiments herein generally relate to cloud security, and more particularly, to a method for automatic detection and remediation of security posture in web-applications using large vision models.

### Description of the Related Art

In web-based applications, ensuring robust security measures is important for safeguarding sensitive data and protecting against potential cyber threats. However, the dynamic nature of these applications coupled with the lack of standardized APIs for administrative tasks poses significant challenges for security professionals tasked with monitoring and maintaining security posture.

Traditionally, security posture assessment in web applications has relied heavily on manual inspection by IT administrators, who navigate through administrative sections to verify security configurations, user access privileges, and integration with third-party applications. This manual approach is not only time-consuming but also prone to human error, leaving potential vulnerabilities undetected and exposing organizations to security breaches.

Moreover, the absence of standardized APIs further complicates the situation, as it restricts the automation of administrative tasks and impedes the seamless integration of security monitoring tools. Without APIs, security professionals are forced to rely on ad-hoc solutions, increasing inefficiencies and limitations of manual inspection.

Accordingly, there remains a need to address the aforementioned technical problems using a method for automatic detection and remediation of security posture in web-applications using large vision models.

### SUMMARY

In view of the foregoing, there is provided a process-implemented method for automated detection of security posture of a web-application by an AI agent using a large vision model. The method includes remotely initiating, by the AI agent, a headless browser to access an administrative section of the web-application, using a privilege of an administrative user of the web-application. The headless browser is a browser without a Graphical User Interface (GUI) that enables automated control of the web application. The method includes automatically capturing, by the AI agent, a first screenshot of a first user interface of the administrative section of the web-application. The method includes providing the first screenshot to query the large vision model. The method includes determining a first state of the first user interface using the large vision model based on the first screenshot. The method includes determining at least one subsequent state to the first state from a state transition graph. The method includes automatically generating and transmitting, by the AI agent, at least one of a keyboard or a mouse input without manually operating a keyboard or a mouse to automatically navigate the web application to a second user interface that corresponds to the at least one subsequent state. The method includes determining if the at least one subsequent state corresponds to a final state in a navigation sequence in the state transition graph. The method includes, upon detecting the final state in the navigation sequence, extracting one or more of security attributes using the large vision model to determine the security posture of the web application.

In some embodiments, the method further includes dynamically generating and displaying a dashboard that includes the one or more security attributes, wherein the one or more security attributes is selected from any of (i) a security configuration of the web application, (ii) an access pattern of a user, or (iii) a third-party application integration.

In some embodiments, the method further includes automatically detecting a potential vulnerability or a security breach based on at least one of the one or more security attributes, and initiating an automated security remediation action upon detecting the potential vulnerability or the security breach in the web-application. The security remediation action is selected from any of (i) automatically adjusting a security setting in the security configuration of the web application, (ii) limiting or revoking a user access privilege, or (iii) revoking at least one of issued Application Programming Interface (API) keys or OAuth tokens to prevent unauthorized access through the third party application.

In some embodiments, the large vision model includes a neural network architecture trained to recognize and interpret visual elements and transitions within web user interfaces.

In some embodiments, the large vision model is periodically updated with training data based on changes to user interfaces of the web application and security requirements.

In some embodiments, the method further includes further reusing context of the browser from a prior subsequent state in the at least one subsequent state by a) storing state-related data in a secure storage database; and b) retrieving the state-related data upon initiating the at least one subsequent state to restore the prior subsequent state, thereby reducing the need to initialize the headless browser to access the administrative section of the web-application repeatedly, thereby improving operational efficiency.

In an aspect, a system for automated detection of security posture of a web-application by an AI agent using a large vision model. The system includes a security posture detection and remediation server that remotely initiate, by the AI agent, a headless browser to access an administrative section of the web-application, using a privilege of an administrative user of the web-application, wherein the headless browser is a browser without a Graphical User Interface (GUI) that enables automated control of the web application. The server includes a memory that includes a set of instructions and a processor that executes the set of instructions. The processor is configured to (i) automatically capture, by the AI agent, a first screenshot of a first user interface of the administrative section of the web-application, (ii) provides the first screenshot to query the large vision model, (iii) determines a first state of the first user interface using the large vision model based on the first screenshot, (iv) determines at least one subsequent state to the first state from a state transition graph, (v) automatically generates and transmits, by the AI agent, at least one of a keyboard or a mouse input without manually operating a keyboard or a mouse to automatically navigate the web application to a second user interface that corresponds to the at least one subsequent state, (vi) determines if the at least one subsequent state corresponds to a final state in a navigation sequence in the state transition graph, (vii) upon detecting the final state in the navigation sequence, extracts one or more of security attributes using the large vision model to determine the security posture of the web application.

In some embodiments, the processor is configured to dynamically generate and display a dashboard that includes the one or more security attributes. The one or more security attributes are selected from any of (i) a security configuration of the web application, (ii) an access pattern of a user, or (iii) a third-party application integration.

In some embodiments, the processor is configured to automatically detect a potential vulnerability or a security breach based on at least one of the one or more of security attributes, and initiate an automated security remediation action upon detecting the potential vulnerability or the security breach in the web-application. The security remediation action is selected from any of (i) automatically adjusting a security setting in the security configuration of the web application, (ii) limiting or revoking a user access privilege, or (iii) revoking at least one of issued Application Programming Interface (API) keys or OAuth tokens to prevent unauthorized access through the third-party application.

In some embodiments, the large vision model includes a neural network architecture trained to recognize and interpret visual elements and transitions within web user interfaces.

In some embodiments, the large vision model is periodically updated with training data that is based on changes to user interfaces of the web application and security requirements.

In some embodiments, the processor is configured to reuse context of the browser from a prior subsequent state in the at least one subsequent state by a) storing state-related data in a secure storage database; and b) retrieving the state-related data upon initiating the at least one subsequent state to restore the prior subsequent state, thereby reducing the need to initialize the headless browser to access the administrative section of the web-application repeatedly, thereby improving operational efficiency.

In another aspect, there is provided one or more non-transitory computer-readable storage mediums storing one or more sequences of instructions, which when executed by one or more processors, causes a method for automated detection of security posture of a web-application by an AI agent using a large vision model. The method includes remotely initiating, by the AI agent, a headless browser to access an administrative section of the web-application, using a privilege of an administrative user of the web-application. The headless browser is a browser without a Graphical User Interface (GUI) that enables automated control of the web application. The method includes automatically capturing, by the AI agent, a first screenshot of a first user interface of the administrative section of the web-application. The method includes providing the first screenshot to query the large vision model. The method includes determining a first state of the first user interface using the large vision model based on the first screenshot. The method includes determining at least one subsequent state to the first state from a state transition graph. The method includes automatically generating and transmitting, by the AI agent, at least one of a keyboard or a mouse input without manually operating a keyboard or a mouse to automatically navigate the web application to a second user interface that corresponds to the at least one subsequent state. The method includes determining if the at least one subsequent state corresponds to a final state in a navigation sequence in the state transition graph. The method includes, upon detecting the final state in the navigation sequence, extracting one or more security attributes using the large vision model to determine the security posture of the web application.

In some embodiments, the method further includes dynamically generating and displaying a dashboard that includes the one or more security attributes, wherein the one or more security attributes is selected from any of (i) a security configuration of the web application, (ii) an access pattern of a user, or (iii) a third-party application integration.

In some embodiments, the method further includes automatically detecting a potential vulnerability or a security breach based on at least one of the one or more security attributes, and initiating an automated security remediation action upon detecting the potential vulnerability or the security breach in the web-application. The security remediation action is selected from any of (i) automatically adjusting a security setting in the security configuration of the web application, (ii) limiting or revoking a user access privilege, or (iii) revoking at least one of issued Application Programming Interface (API) keys or OAuth tokens to prevent unauthorized access through the third party application.

In some embodiments, the large vision model includes a neural network architecture trained to recognize and interpret visual elements and transitions within web user interfaces.

In some embodiments, the large vision model is periodically updated with training data based on changes to user interfaces of the web application and security requirements.

In some embodiments, the method further includes further reusing context of the browser from a prior subsequent state in the at least one subsequent state by a) storing state-related data in a secure storage database; and b) retrieving the state-related data upon initiating the at least one subsequent state to restore the prior subsequent state, thereby reducing the need to initialize the headless browser to access the administrative section of the web-application repeatedly, thereby improving operational efficiency.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system for automatic detection and remediation of security posture in web-applications using large vision models according to some embodiments herein;

FIG. 2 illustrates an exploded view of the security posture detection and remediation server of FIG. 1 according to some embodiments herein;

FIG. 3 illustrates a high-level architecture for automatic detection and remediation of security posture in web-applications using large vision models according to some embodiments herein;

FIG. 4 illustrates a state transition graph utilized by the AI agent for automated security posture detection in a web application according to some embodiments herein;

FIG. 5 illustrates the end-to-end process of security posture assessment using a pre-trained vision model according to some embodiments herein;

FIGS. 6A and 6B are flow diagrams that illustrate a method for automatic detection and remediation of security posture in web-applications using large vision models according to some embodiments herein;

FIG. 7 is a representative cloud computing environment for practicing the embodiments herein; and

FIG. 8 is a representative hardware environment for practicing the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the view of the foregoing, for automatic detection and remediation of security posture in web-applications using large vision models is fulfilled in the ongoing description by (a) initiating a headless browser as an agent to access an administrative section of a web-application, wherein the headless browser is remotely executed using privileges of an administrative user of the web-application, (b) enabling a pre-trained large vision model to navigate through a web user-interface of the web-application using a state transition graph, (c) determining subsequent navigation actions of the navigated web-user interface using screenshots of the navigated web-user interface and simulating keyboard and mouse inputs associated with the subsequent navigation actions on the web user-interface, (d) detecting and analyzing a final state of navigation sequence of the administrative section to extract security attributes, wherein the security attributes include users, roles, configurations, current state, machine identities, and scopes, (e) monitoring and collecting, using the agent, data associated with security posture of the web-application to assess effectiveness of security configurations of the web-application, track access patterns of users, and evaluate security implications of third-party app integrations based on the security attributes, and (f) initiating automated corrective actions through a security posture remediation module upon identifying a security issue in the web-application.

The term “headless browser” refers to a web browser without a graphical user interface (GUI) that enables automated browsing and interaction with web content programmatically via command-line interfaces or scripts. This type of browser enables automated control of a webpage in an environment similar to popular browsers like Chrome or Firefox, but it runs in the background, often on a server. The headless browser is primarily used for web scraping, automated testing of web applications, and rendering web pages for search engine optimization (SEO). They can perform all the actions that a regular browser can, such as page navigation, form submission, JavaScript execution, and handling cookies, but faster and more efficiently since they don't need to load images or apply CSS styles meant for human viewing.

The term “pre-trained large vision model” refers to a computational framework, typically based on deep learning techniques, which has been trained on vast amounts of visual data to recognize patterns, features, and objects within images. This model is capable of interpreting and processing visual information akin to human vision, facilitating tasks such as object detection, image classification, and scene understanding. This model leverages deep learning, a subset of machine learning, where artificial neural networks with multiple layers-hence the term “deep”-learn from vast amounts of visual data. These networks are structured in a hierarchical manner, where each layer progressively extracts and abstracts information from the input images.

The term “security posture” refers to the overall defensive state and resilience of a system, network, or application against potential cybersecurity threats and attacks. It encompasses various factors, including security configurations, access controls, monitoring mechanisms, and incident response procedures. This posture is shaped by various parameters, including the security configurations set within the application, the management of user access, and the integration of third-party applications. These third-party entities may interact with the primary application through mechanisms such as issued API Keys or OAuth tokens, which enable secure, controlled access.

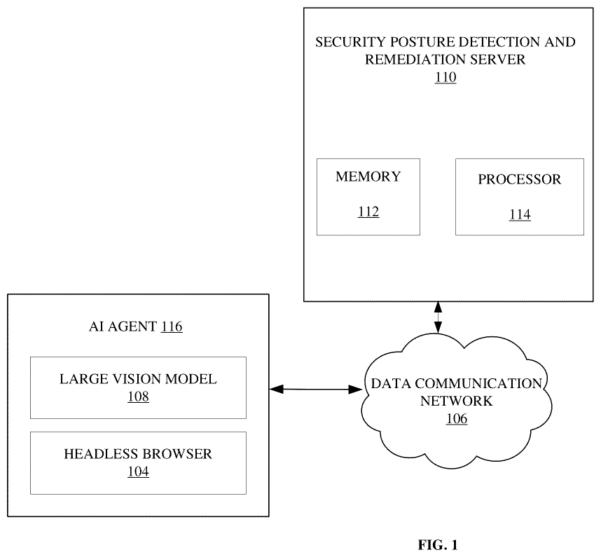

Referring now to the drawings, and more particularly to FIGS. 1 through 6, where similar reference characters denote corresponding features in a consistent manner throughout the figures, there are shown preferred embodiments.

FIG. 1 illustrates a system for automatically detecting and remediating security posture in web applications using large vision models, according to some embodiments herein. The system includes an artificial intelligence (AI) agent 116, a data communication network 106, and a security posture detection and remediation server 110. The AI agent 116 includes a large vision model 108, and a headless browser 104. The large vision model 108 includes a neural network architecture trained to recognize and interpret visual elements and transitions within web user interfaces. The system receives raw image data (i.e. UI screenshots). The system preprocesses the received raw image data using a normalization method, and an augmentation method. The LVM uses convolutional layers and activation functions to detect patterns in UI elements. The system extracts visual features from the pre-processed raw data. The extracted visual features are passed through fully connected layers, allowing the LVM 108 to recognize patterns in the UI elements. The LVM 108 outputs predictions such as object classification (e.g., identifying login fields, access controls) and scene interpretation (e.g., recognizing security configurations). The LVM 108 is trained using backpropagation, optimization algorithms, and regularization techniques to improve accuracy. The large vision model 108 includes pooling layers that reduce dimensionality while retaining important visual features.

The data communication network 106 may be a combination of a wired network or a wireless network. The data communication network 106 may be an Internet. The security posture detection and remediation server 110 includes a memory 112 that stores a database and a set of instructions. The security posture detection and remediation server 110 includes a processor 114 in communication with the memory and retrieves and executes the set of instructions from the memory 112.

The security posture detection and remediation server 110 is communicatively connected to the AI agent 116 to initiate the headless browser 104 as the AI agent 116 to access an administrative section of the web-application. The headless browser 104 is remotely executed using privileges of an administrative user of the web-application. The security posture detection and remediation server 110 enables a pre-trained large vision model to navigate through a web user-interface of the web-application using a state transition graph. The security posture detection and remediation server 110 automatically captures a first screenshot of a first user interface of the administrative section of the web-application. The AI agent 116 provides the first screenshot to query the large vision model 108.

The security posture detection and remediation server 110 determines a first state of the first user interface based on the first screenshot. The security posture detection and remediation server 110 determines the first state using the large vision model 108. The security posture detection and remediation server 110 determines one or more subsequent states to the first state from the state transition graph.

The security posture detection and remediation server 110 determines subsequent state or navigation actions of the navigated web-user interface using screenshots of the navigated web-user interface with the large vision model 108. The security posture detection and remediation server 110 simulates keyboard and mouse inputs associated with the subsequent navigation actions on the web user-interface without manually operating a keyboard or a mouse. The AI agent 116 automatically transmits the keyboard or a mouse input to navigate the web application to a second user interface that corresponds to the at least one subsequent state. The security posture detection and remediation server 110 determines if the at least one subsequent state corresponds to a final state in a navigation sequence in the state transition graph.

The security posture detection and remediation server 110 detects and analyzes a final state of the navigation sequence of the administrative section to extract security attributes. The large vision model 108 extracts the security attributes to determine the security posture of the web application. The security attributes include (i) a security configuration of the web application, (ii) an access pattern of a user, or (iii) a third-party application integration. The security attributes include users, roles, configurations, current state, machine identities, and scopes.

The security posture detection and remediation server 110 dynamically generates and displays a dashboard that includes the security attributes. The security posture detection and remediation server 110 automatically detects a potential vulnerability or a security breach based on the security attributes. The security posture detection and remediation server 110 initiates an automated security remediation action upon detecting the potential vulnerability or the security breach in the web-application using a remediation module. The security remediation action is (i) automatically adjusting a security setting in the security configuration of the web application, (ii) limiting or revoking a user access privilege, or (iii) revoking at least one of issued Application Programming Interface (API) keys or OAuth tokens to prevent unauthorized access through a third-party application. The remediation module is designed to resolve identified security threats. The remediation module also manages user access. When unauthorized or suspicious activity is detected, the remediation module restricts or revokes user privileges, mitigating potential internal threats or data breaches. Additionally, the remediation module oversees third-party integrations by monitoring the usage and permissions of issued API keys and OAuth tokens. If misuse or redundancy is detected, the remediation module can revoke these credentials, preventing unauthorized external access.

The large vision model 108 is periodically updated with training data based on changes to user interfaces of the web application and security requirements. The security posture detection and remediation server 110 initiates the at least one subsequent state to restore the prior subsequent state. The large vision model 108 reuses context of the browser from a prior subsequent state in the at least one subsequent state by a) storing state-related data in a secure storage database and b) retrieving the state-related data, thereby reducing the need to initialize the headless browser to access the administrative section of the web-application repeatedly, thereby improving operational efficiency.

The system is advantageous that the system utilizes a headless browser as an agent and employs a pre-trained large vision model for achieving a high degree of automation in navigating through the web user interface. This automation significantly reduces the burden of manual inspection, saving valuable time and resources.

Further, the system facilitates real-time monitoring and collection of data associated with the security posture of the web application. This proactive approach enables continuous assessment of security configurations, tracking of user access patterns, and evaluation of security implications stemming from third-party app integrations. By identifying security issues promptly and initiating automated corrective actions through a security posture remediation module, the system enhances the overall resilience of web-based applications against potential cyber threats. In some embodiments, the final state detection mechanism employs pattern recognition algorithms to identify conclusive states in the navigation sequence.

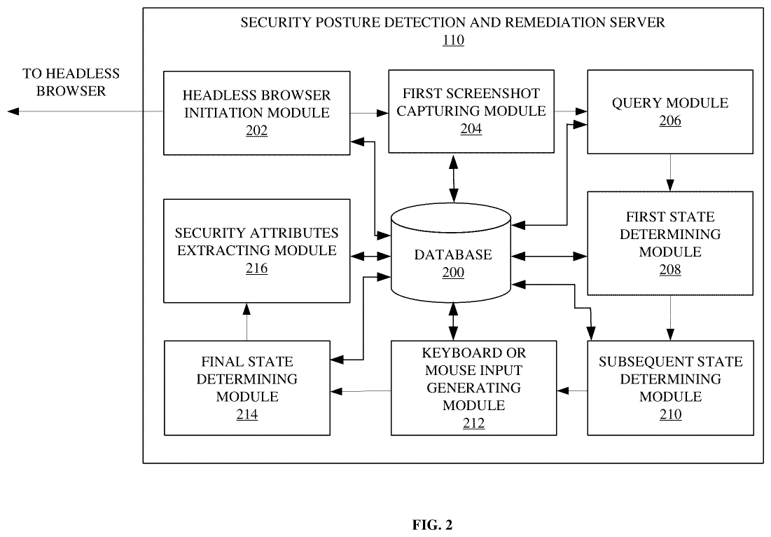

FIG. 2 illustrates an exploded view of the security posture detection and remediation server 110 of FIG. 1 according to some embodiments herein. The security posture detection and remediation server 110 includes a headless browser initiation module 202, a first screenshot capturing module 204, a query module 206, a first state determining module 208, a subsequent state determining module 210, a keyboard or mouse input generating module 212, a final state determining module 214, a security attributes extracting module 216 and a database 200.

The headless browser initiation module 202 remotely initiates, by the AI agent 116, a headless browser to access an administrative section of the web-application, using a privilege of an administrative user of the web-application. The headless browser is a browser without a Graphical User Interface (GUI) that enables automated control of the web application.

The first screenshot capturing module 204 automatically captures, by the AI agent 116, a first screenshot of a first user interface of the administrative section of the web-application. The query module 206 provides the first screenshot to query the large vision model 108. The first state determining module 208 determines a first state of the first user interface using the large vision model 108 based on the first screenshot. The subsequent state determining module 210 determines at least one subsequent state to the first state from a state transition graph.

The keyboard or mouse input generating module 212 automatically generates and transmits, by the AI agent 116, at least one of a keyboard or a mouse input without manually operating a keyboard or a mouse to automatically navigate the web application to a second user interface that corresponds to the at least one subsequent state. The final state determining module 214 determines if the at least one subsequent state corresponds to a final state in a navigation sequence in the state transition graph. The security attributes extracting module 216 extracts one or more security attributes using the large vision model to determine the security posture of the web application upon detecting the final state in the navigation sequence.

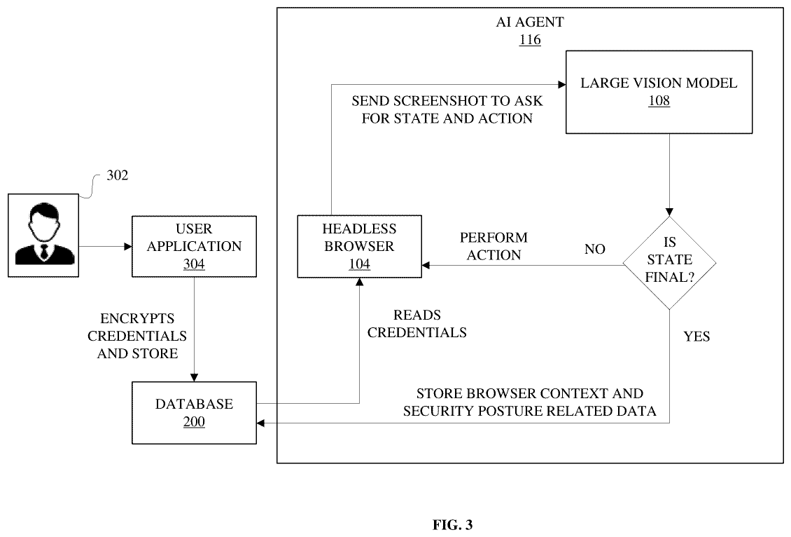

FIG. 3 illustrates a high-level architecture for automatic detection and remediation of security posture in web-applications using large vision models according to some embodiments herein. The high-level architecture includes a user 302, a user application 304, a database 200, an AI agent 116 that includes a headless browser 104 and a large vision model 108. The user 302 interacts with the user application 304 that encrypts credentials and stores the credentials on the database 200. The headless browser 104 reads credentials from the database 200 and sends a screenshot to ask for state and action to the large vision model 108. If the state is not determined as final, then the headless browser 104 again sends the screenshot to ask for the state and action to the large vision model 108. If the state is determined as final, browser context and security posture related data is stored in the database 200.

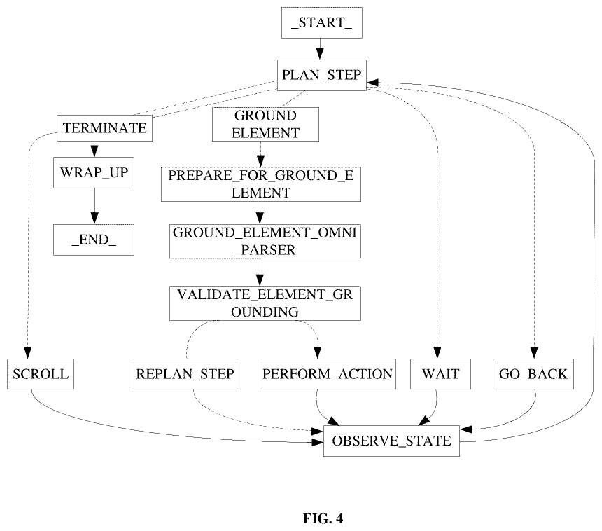

FIG. 4 illustrates a state transition graph utilized by the AI agent 116 for automated security posture detection in a web application of FIG. 1 according to some embodiments herein. The Large Vision Model 108 processes the first screenshot of the first user interface (UI). The LVM 108 recognizes UI components like buttons, text fields, icons, and menus. The LVM 10 identifies the current UI state of the first user interface. This corresponds to the “_start_state” in the state transition graph (STG), which then moves to “plan_step”.

The state transition graph maps all possible UI states and transitions between them. The system checks possible next states from the “plan_step” by following transitions such as “ground_element” (processing UI elements), scroll, wait, go_back (the AI agent actions), “perform_action” (executing an interaction)

For example, if the initial UI is a login screen, possible next states may be a dashboard (successful login), a failed login page (incorrect credentials), a password reset page (alternative flow). The system continues transitioning between states until it identifies a final state in the UI sequence. The system tracks navigation steps to determine if the user has reached the final state in the login flow.

Another example, the system initiates its analysis by determining where to go first on the web application, such as the login page (_start→plan_step). The system checks the login page to locate input fields and buttons through “prepare_for_ground_element”, reads the structure of the login page through “ground_element_omni_parser”, and checks the AI agent whether it identifies the correct input fields and buttons (not fake ones or hidden traps). The system enters login details and clicks the login button through “perform_action”. If the login fails, the system (i) goes back and retries with different credentials or (ii) scrolls to check for error messages or additional UI elements that might impact the navigation process or (iii) goes back to reanalyze the login page. If the login succeeds, the system enters the admin panel.

The AI agent checks and extracts security attributes of the admin panel. If unexpected behavior is encountered, the system may “replan_step” to adapt its approach (i.e., Adjusts the navigation strategy if the expected transition fails). If the process is complete, it transitions to wrap_up and then to the end state (_end_).

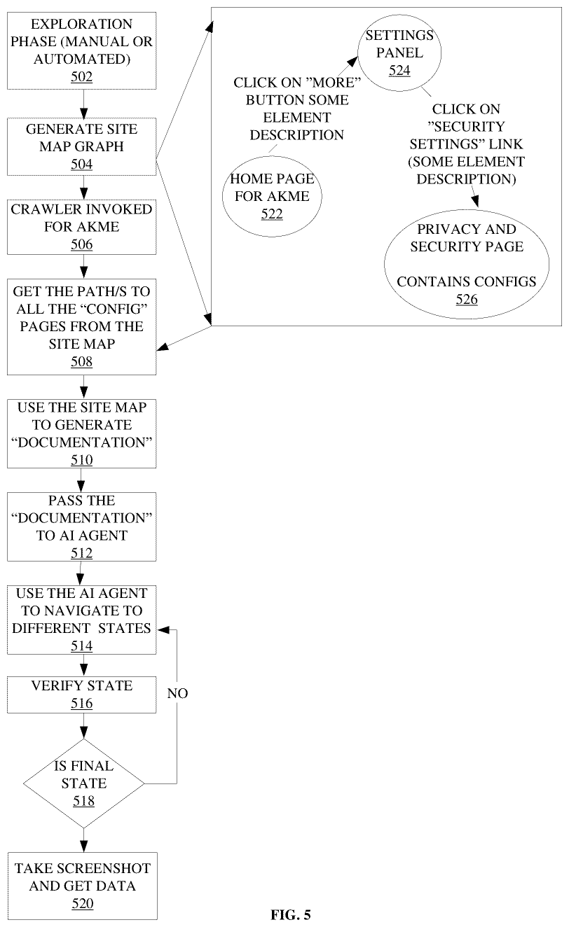

FIG. 5 illustrates the end-to-end process of security posture assessment using a pre-trained large vision model according to some embodiments herein. In step 502, the method includes initiating with an exploration phase to interpret a structure and functionality of the web application. The exploration can be done manually by a user or automatically by a web crawler to identify interface elements, navigational paths, and security-related configurations. In step 504, the method includes generating a site map graph to represent a hierarchical structure and navigation flow of the web application. The site map graph provides a visual representation of pages, links, and transitions, allowing for efficient state AI-driven navigation.

In step 506, the method includes deploying the web crawler to traverse the web application and gather detailed information about the hierarchical structure of the web application. The crawler identifies pages, menus, buttons, interactive User Interface (UI) elements, security-relevant settings (e.g., user roles, authentication, permissions). The web crawler ensures that the large vision model (LVM) has a complete understanding of interfaces of the web application.

In step 508, the method includes obtaining paths to all configuration pages from the site map graph. This step ensures that the LVM extracts configuration pages such as privacy settings, and user authentication configurations. In step 510, the method includes generating a documentation of the obtained paths using the sitemap graph, allowing the LVM to interpret the UI transitions.

In step 512, the method includes feeding the documentation to an AI agent driven by the large vision model. The large vision model utilizes a neural network architecture trained to recognize the UI components of the web application. In step 514, the method includes navigating, by the AI agent, through different states of the interfaces of the web application using an image recognition module. The image recognition module captures and processes a first screenshot, and an inference engine that queries the large vision model to determine the next navigation step.

In steps of 516, and 518, (i) determining a first state of the first user interface using the large vision model based on the first screenshot, (ii) determining at least one subsequent state to the first state from a state transition graph, (iii) automatically generating and transmitting, by the AI agent, at least one of a keyboard or a mouse input without manually operating a keyboard or a mouse to automatically navigate the web application to a second user interface that corresponds to the at least one subsequent state, (iv) determining if the at least one subsequent state corresponds to a final state in a navigation sequence in the state transition graph, (v) if the final state is not reached, the AI agent continues navigation by revisiting previous steps and (vi) if the final state is identified, the process proceeds to data extraction.

In steps of 520, upon reaching the final state, the system captures a screenshot of the web UI to extract security posture.

The site map graph illustrates the flow of navigation:
Home Page of the web application
Clicking on “more” leads to the Settings Panel.
Clicking on “Security Settings” leads to the Privacy and Security Page, which contains security configurations. This structured flow allows the AI agent to efficiently locate and analyze the security attributes.

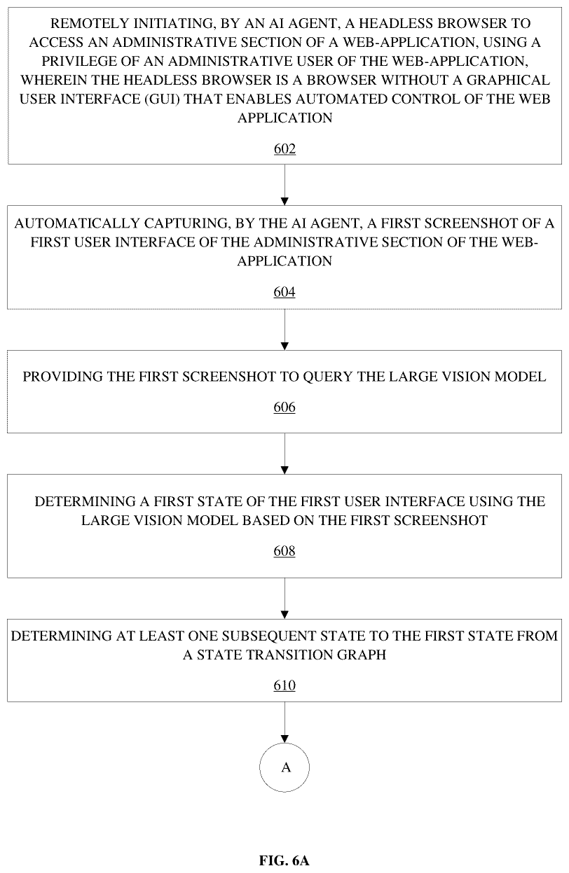

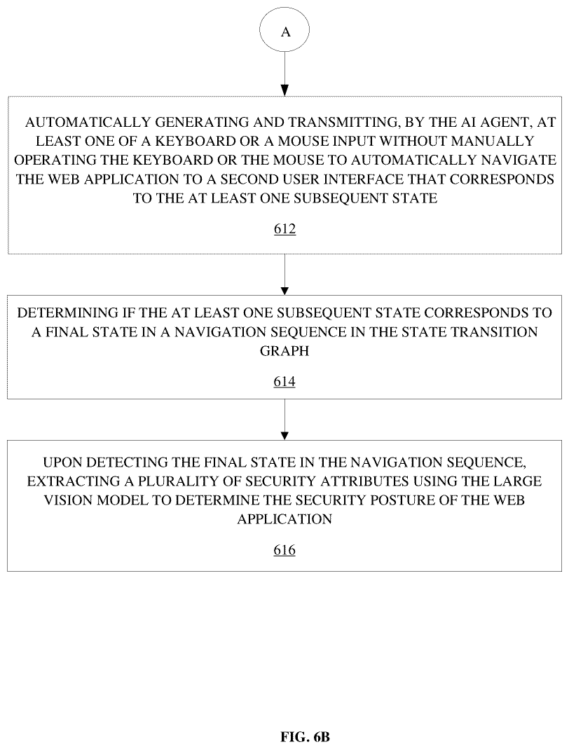

FIGS. 6A and 6B are flow diagrams that illustrate a method for automatic detection and remediation of security posture in web-applications using large vision models according to some embodiments herein. At step 602, the method includes remotely initiating, by the AI agent, a headless browser to access an administrative section of the web-application, using a privilege of an administrative user of the web-application. The headless browser is a browser without a Graphical User Interface (GUI) that enables automated control of the web application. At step 604, the method includes automatically capturing, by the AI agent, a first screenshot of a first user interface of the administrative section of the web-application.

At step 606, the method includes providing the first screenshot to query the large vision model. At step 608, the method includes determining a first state of the first user interface using the large vision model based on the first screenshot. At step 610, the method includes determining at least one subsequent state to the first state from a state transition graph. At step 612, the method includes automatically generating and transmitting, by the AI agent, at least one of a keyboard or a mouse input without manually operating a keyboard or a mouse to automatically navigate the web application to a second user interface that corresponds to the at least one subsequent state. At step 614, the method includes determining if the at least one subsequent state corresponds to a final state in a navigation sequence in the state transition graph. At step 616, the method includes upon detecting the final state in the navigation sequence, extracting a plurality of security attributes using the large vision model to determine the security posture of the web application.

The method is of advantage that the method utilizes a headless browser as an agent and employs a pre-trained large vision model for achieving a high degree of automation in navigating through the web user interface. This automation significantly reduces the burden of manual inspection, saving valuable time and resources.

Further, the method facilitates real-time monitoring and collection of data associated with the security posture of the web application. This proactive approach enables continuous assessment of security configurations, tracking of user access patterns, and evaluation of security implications stemming from third-party app integrations. By identifying security issues promptly and initiating automated corrective actions through a security posture remediation module, the method enhances the overall resilience of web-based applications against potential cyber threats.

The various systems and corresponding components described herein and/or illustrated in the figures may be embodied or utilized in different cloud computing environments, including a distributed data processing environment or distributed computing environments. It is to be understood that although a detailed description of a cloud computing environment is provided, implementation of the teachings provided herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources, e.g., networks, network bandwidth, servers, processing, memory, storage, applications, virtual machines, and services, that can be rapidly provisioned and released with minimal management effort or interaction with a provider of the service. A cloud computing environment is service oriented with a focus on statelessness, low coupling, modularity, and semantic interoperability. Essentially, cloud computing is an infrastructure that includes a network of interconnected nodes. As an example, a cloud computing environment may include one or more cloud computing nodes with which local computing devices used by cloud consumers, such as, for example, cellular telephone, desktop computer, laptop computer, and/or automobile computer system may communicate. The one or more cloud computing nodes may communicate with one another and may be grouped physically or virtually, in one or more networks, such as private, community, public, or hybrid clouds as described hereinabove, or a combination thereof. This allows the cloud computing environment to offer infrastructure, platforms and/or software as services for which a cloud consumer does not need to maintain resources on a local computing device. It is understood that one or more cloud computing nodes and the cloud computing environment can communicate with any type of computerized device over any type of network and/or network addressable connection, e.g., using a web browser.

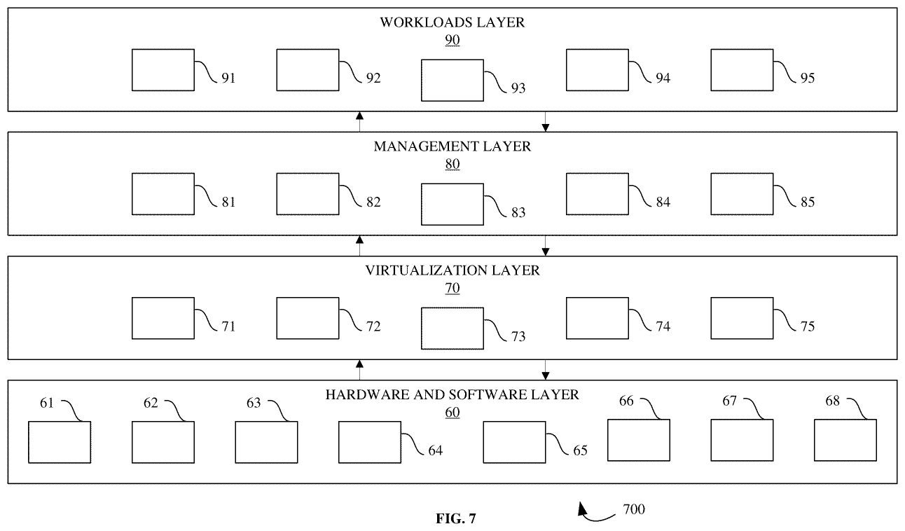

Referring now to FIG. 7, a representative cloud computing environment 500 comprising a set of functional abstraction layers are shown. It should be understood in advance that the components, layers, and functions shown in FIG. 7 are intended to be illustrative only and embodiments of the invention are not limited thereto. As depicted, the following layers and corresponding functions are provided. A hardware and software layer 60 includes hardware and software components. Examples of hardware components include mainframes 61, RISC (Reduced Instruction Set Computer) architecture-based servers 62, servers 63, blade servers 64, storage devices 65, and networks and networking components 66. In some embodiments, software components include network application server software 67 and database software 68. A virtualization layer 70 provides an abstraction layer from which the following examples of virtual entities may be provided virtual servers 71, virtual storage 72, virtual networks 73, including virtual private networks, virtual applications and operating systems 74, and virtual clients 75.

In one example, management layer 80 may provide the functions described below. Resource provisioning 81 provides dynamic procurement of computing resources and other resources that are utilized to perform tasks within the cloud computing environment 500. Metering and pricing 82 provide cost tracking as resources are utilized within the cloud computing environment 500, and billing or invoicing for consumption of these resources. In one example, these resources may include application software licenses. Security provides identity verification for cloud consumers and tasks, as well as protection for data and other resources. User portal 83 provides access to the cloud computing environment 500 for consumers and system administrators. Service level management 84 provides cloud computing resource allocation and management such that required service levels are met.

Workloads layer 90 provides examples of functionality for which the cloud computing environment 500 may be utilized. Examples of workloads and functions which may be provided from this layer include mapping and navigation 91, software development and lifecycle management 92, virtual classroom education delivery 93, data analytics processing 94, transaction processing 95, and microservice recipe creation 96.

The embodiments herein can take the form of a computer program product accessible from a computer-usable or computer-readable medium providing program code for use by or in connection with a computer or any instruction execution system. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM) and, a rigid magnetic disk.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

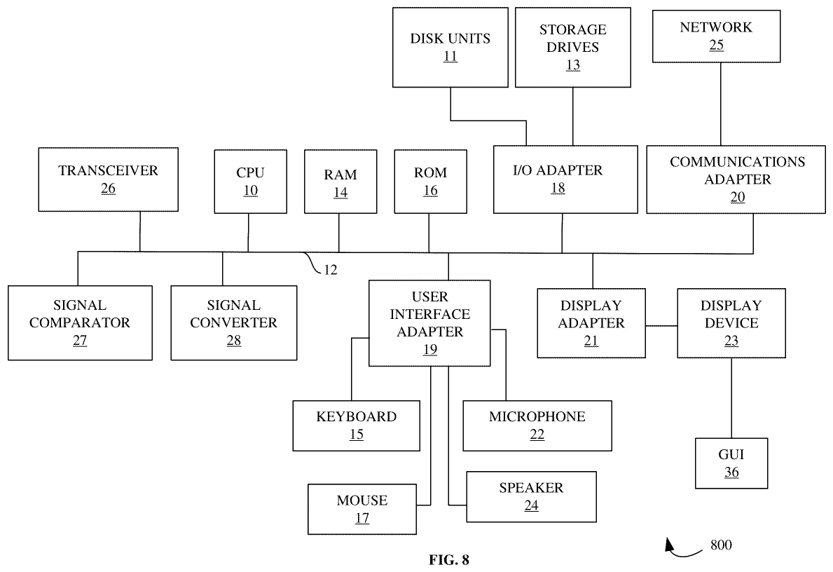

A representative hardware environment for practicing the embodiments herein is depicted in FIG. 8, with reference to FIGS. 1 through 6A and 6B. This schematic drawing illustrates a hardware configuration of a software development device/computer system 600 in accordance with the embodiments herein. The system includes at least one processor or central processing unit (CPU) 10. The CPUs 10 are interconnected via system bus 12 to various devices such as a random-access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system 600 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network, and a display adapter 21 connects the bus 12 to a display device 23, which provides a graphical entity interface (GUI) 36 of the output data in accordance with the embodiments herein, or which may be embodied as an output device such as a monitor, printer, or transmitter, for example. Further, a transceiver 26, a signal comparator 27, and a signal converter 28 may be connected with the bus 12 for processing, transmission, receipt, comparison, and conversion of electric signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope.

What is claimed is:

1. A processor-implemented method for automated detection of security posture of a web-application by an AI agent using a large vision model, the method comprising:
remotely initiating, by the AI agent, a headless browser to access an administrative section of the web-application, using a privilege of an administrative user of the web-application, wherein the headless browser is a browser without a Graphical User Interface (GUI) that enables automated control of the web application;
automatically capturing, by the AI agent, a first screenshot of a first user interface of the administrative section of the web-application;
providing the first screenshot to query the large vision model;
determining a first state of the first user interface using the large vision model based on the first screenshot;
determining at least one subsequent state to the first state from a state transition graph;
automatically generating and transmitting, by the AI agent, at least one of a keyboard or a mouse input without manually operating a keyboard or a mouse to automatically navigate the web application to a second user interface that corresponds to the at least one subsequent state;
determining if the at least one subsequent state corresponds to a final state in a navigation sequence in the state transition graph; and
upon detecting the final state in the navigation sequence, extracting a plurality of security attributes using the large vision model to determine the security posture of the web application.

2. The processor-implemented method of claim 1, further comprising dynamically generating and displaying a dashboard that comprises the plurality of the security attributes, wherein the plurality of the security attributes is selected from any of (i) a security configuration of the web application, (ii) an access pattern of a user, or (iii) a third-party application integration.

3. The processor-implemented method of claim 2, further comprising automatically detecting a potential vulnerability or a security breach based on at least one of the plurality of security attributes, and initiating an automated security remediation action upon detecting the potential vulnerability or the security breach in the web-application, wherein the security remediation action is selected from any of (i) automatically adjusting a security setting in the security configuration of the web application, (ii) limiting or revoking a user access privilege, or (iii) revoking at least one of issued Application Programming Interface (API) keys or OAuth tokens to prevent unauthorized access through the third party application.

4. The processor-implemented method of claim 1, wherein the large vision model comprises a neural network architecture trained to recognize and interpret visual elements and transitions within web user interfaces.

5. The processor-implemented method of claim 1, wherein the large vision model is periodically updated with training data based on changes to user interfaces of the web application and security requirements.

6. The processor-implemented method of claim 1, further comprising reusing context of the browser from a prior subsequent state in the at least one subsequent state by a) storing state-related data in a secure storage database; and b) retrieving the state-related data upon initiating the at least one subsequent state to restore the prior subsequent state, thereby reducing the need to initialize the headless browser to access the administrative section of the web-application repeatedly, thereby improving operational efficiency.

7. A system for automated detection of security posture of a web-application by an AI agent using a large vision model, the system comprising:
a security posture detection and remediation server that remotely initiate, by the AI agent, a headless browser to access an administrative section of the web-application, using a privilege of an administrative user of the web-application, wherein the headless browser is a browser without a Graphical User Interface (GUI) that enables automated control of the web application and the server comprises:
a memory that comprises a set of instructions;
a processor that executes the set of instructions and is configured to:
automatically captures, by the AI agent, a first screenshot of a first user interface of the administrative section of the web-application;
provides the first screenshot to query the large vision model;
determines a first state of the first user interface using the large vision model based on the first screenshot;
determines at least one subsequent state to the first state from a state transition graph;
automatically generates and transmits, by the AI agent, at least one of a keyboard or a mouse input without manually operating a keyboard or a mouse to automatically navigate the web application to a second user interface that corresponds to the at least one subsequent state;
determines if the at least one subsequent state corresponds to a final state in a navigation sequence in the state transition graph; and
upon detecting the final state in the navigation sequence, extracts a plurality of security attributes using the large vision model to determine the security posture of the web application.

8. The system of claim 7, wherein the processor is configured to dynamically generate and display a dashboard that comprises the plurality of the security attributes, wherein the plurality of the security attributes is selected from any of (i) a security configuration of the web application, (ii) an access pattern of a user, or (iii) a third-party application integration.

9. The system of claim 8, wherein the processor is configured to automatically detect a potential vulnerability or a security breach based on at least one of the plurality of security attributes, and initiating an automated security remediation action upon detecting the potential vulnerability or the security breach in the web-application, wherein the security remediation action is selected from any of (i) automatically adjusting a security setting in the security configuration of the web application, (ii) limiting or revoking a user access privilege, or (iii) revoking at least one of issued Application Programming Interface (API) keys or OAuth tokens to prevent unauthorized access through the third party application.

10. The system of claim 7, wherein the large vision model comprises a neural network architecture trained to recognize and interpret visual elements and transitions within web user interfaces.

11. The system of claim 7, wherein the large vision model is periodically updated with training data that is based on changes to user interfaces of the web application and security requirements.

12. The system of claim 7, wherein the processor is configured to reuse context of the browser from a prior subsequent state in the at least one subsequent state by a) storing state-related data in a secure storage database; and b) retrieving the state-related data upon initiating the at least one subsequent state to restore the prior subsequent state, thereby reducing the need to initialize the headless browser to access the administrative section of the web-application repeatedly, thereby improving operational efficiency.

13. One or more non-transitory computer-readable storage mediums storing one or sequences of instructions, which when executed by one or more processors, causes a method for automated detection of security posture of a web-application by an AI agent using a large vision model, the method comprising:
remotely initiating, by the AI agent, a headless browser to access an administrative section of the web-application, using a privilege of an administrative user of the web-application, wherein the headless browser is a browser without a Graphical User Interface (GUI) that enables automated control of the web application;
automatically capturing, by the AI agent, a first screenshot of a first user interface of the administrative section of the web-application;
providing the first screenshot to query the large vision model;
determining a first state of the first user interface using the large vision model based on the first screenshot;
determining at least one subsequent state to the first state from a state transition graph;
automatically generating and transmitting, by the AI agent, at least one of a keyboard or a mouse input without manually operating a keyboard or a mouse to automatically navigate the web application to a second user interface that corresponds to the at least one subsequent state;
determining if the at least one subsequent state corresponds to a final state in a navigation sequence in the state transition graph; and
upon detecting the final state in the navigation sequence, extracting a plurality of security attributes using the large vision model to determine the security posture of the web application.

14. One or more non-transitory computer-readable storage mediums storing one or sequences of instructions of claim 13, which when executed by one or more processors, further comprises dynamically generating and displaying a dashboard that comprises the plurality of the security attributes, wherein the plurality of the security attributes is selected from any of (i) a security configuration of the web application, (ii) an access pattern of a user, or (iii) a third-party application integration.

15. One or more non-transitory computer-readable storage mediums storing one or sequences of instructions of claim 14, which when executed by one or more processors, further comprises automatically detecting a potential vulnerability or a security breach based on at least one of the plurality of security attributes, and initiating an automated security remediation action upon detecting the potential vulnerability or the security breach in the web-application, wherein the security remediation action is selected from any of (i) automatically adjusting a security setting in the security configuration of the web application, (ii) limiting or revoking a user access privilege, or (iii) revoking at least one of issued Application Programming Interface (API) keys or OAuth tokens to prevent unauthorized access through the third party application.

16. One or more non-transitory computer-readable storage mediums storing one or sequences of instructions of claim 13, wherein the large vision model comprises a neural network architecture trained to recognize and interpret visual elements and transitions within web user interfaces.

17. One or more non-transitory computer-readable storage mediums storing one or sequences of instructions of claim 13, wherein the large vision model is periodically updated with training data that is based on changes to user interfaces of the web application and security requirement.

18. One or more non-transitory computer-readable storage mediums storing one or sequences of instructions of claim 13, which when executed by one or more processors, further comprises reusing context of the browser from a prior subsequent state in the at least one subsequent state by a) storing state-related data in a secure storage database; and b) retrieving the state-related data upon initiating the at least one subsequent state to restore the prior subsequent state, thereby reducing the need to initialize the headless browser to access the administrative section of the web-application repeatedly, thereby improving operational efficiency.
